(19) United States
(12) Patent Application Publication
(10) Pub. No.: US 2026/0248260 A1
(43) Pub. Date: Aug. 27, 2026

(54) HAIR CUTTING GUIDE

(71) Applicant: Pickuls Gizmo Ltd, Loughborough (GB)

(72) Inventor: Joseph James MARSON, Loughborough (GB)

(21) Appl. No.: 19/544,123

(22) Filed: Feb. 19, 2026

(30) Foreign Application Priority Data
Feb. 20, 2025 (GB) 2502455.5

(51) Int. Cl. A45D 24/36

(52) U.S. Cl. CPC A45D 24/36

(57) ABSTRACT

A hair cutting guide consisting of a first handle adapted to be held by a user and having a distal end and a proximal end, a second handle adapted to be held by a user and having a distal end and a proximal end; and a guide member comprising a plurality of parallel comb teeth, each extending along a length from a proximal end to a distal end. The distal end of the first handle and the distal end of the second handle are each attached to opposing lateral sides of the guide member; the comb teeth are attached to one another; and a depth of the comb teeth perpendicular to the lengths of the comb teeth increases from being relatively shallow at the proximal ends of the comb teeth to relatively deeper at the distal ends of the comb teeth to define a taper for haircutting.

### CROSS-REFERENCE PARAGRAPH TO RELATED APPLICATION(S)

This application claims priority to United Kingdom Patent Application No. 2502455.5, filed on Feb. 20, 2025, the entire content of which is incorporated by reference herein.

### FIELD OF THE INVENTION

The present invention relates to hairdressing, particularly hair cuts carried out using mechanical clippers or similar apparatus

### BACKGROUND TO THE INVENTION

Mechanical clippers are often used to cut hair and can be used to produce a uniform haircut with relative ease. Mechanical hair clippers are often provided with clipper guard attachments that allow a user to cut a person's hair to a different standard length. This is achieved by attaching the clipper guard to the cutting end of the clippers, the clipper guard being formed to maintain the comb a minimum distance away from the scalp of a person having their hair cut. By using a clipper guard of an appropriate length a uniform haircut of a selected length can be achieved with relative ease.

More complicated hairstyles can be achieved by skilled hairdressers using mechanical clippers. For example, tapers, fades, and flat top hairstyles can all be achieved utilising mechanical clippers. In order to achieve these hairstyles significant skill is required and the use of several clipper guards of different sizes is often required.

Unskilled people often attempt to cut their own hair or the hair of others or relatives using mechanical clippers. Reasons for this include hairdressers being shut, saving money, people in care environments who can't easily access hairdressers, and simply for convenience. Whilst uniformly short haircuts are relatively easily to achieve, more complicated hairstyles are much more difficult and require significant skill and attempts by unskilled people often result in bad outcomes.

GB2603007 discloses a hair cutting guide for cutting tapered hair. This hair cutting guide is advantageous in that it provides a simple apparatus suitable for use with mechanical clippers that allows a relatively unskilled person to produce a tapered haircut. The hair cutting guide of GB2603007 consists of a handle adapted to be held by a user and having a distal end and a proximal end; and a guide member comprising a plurality of parallel comb teeth, each attached to one another, and extending along a length from a proximal end to a distal end, wherein the distal end of the handle is attached to the guide member; and a depth of the comb teeth perpendicular to the lengths of the comb teeth increases from being relatively shallow at the proximal ends of the comb teeth to relatively deeper at the distal ends of the comb teeth to define a taper for haircutting.

The hair cutting guide of GB2603007 is excellent for its intended purpose but can be difficult to use by people who are left-handed (for right-handed versions) or who are cutting their own hair. In light of this there is a need for an improved hair cutting guide that can be universally used and that people can use to cut their own hair more easily.

### SUMMARY OF THE INVENTION

The present invention provides a hair cutting guide consisting of:
a first handle adapted to be held by a user and having a distal end and a proximal end;
a second handle adapted to be held by a user and having a distal end and a proximal end; and
a guide member comprising a plurality of parallel comb teeth, each attached to one another,
and extending along a length from a proximal end to a distal end;
wherein:
the distal end of the first handle is attached to a first side the guide member;
the distal end of the second handle is attached to a second side of the guide member, opposing the first side; and
a depth of the comb teeth perpendicular to the lengths of the comb teeth increases from being relatively shallow at the proximal ends of the comb teeth to relatively deeper at the distal ends of the comb teeth to define a taper for haircutting.

The present invention is advantageous in that it provides a simple apparatus suitable for use with mechanical clippers to produce a tapered haircut. In particular, by holding the hair cutting guide in an appropriate position on a person's head, using either or both of the first handle and the second handle, and running mechanical clippers up an outer side of the guide member a tapered portion of hair can be produced. The average unskilled person will understand which parts of a person's hair are required and in what orientation the taper is required to be, all that is generally lacking is the skill to produce the taper. The present invention makes the process of producing a taper much simpler, removing the skill aspect from and requiring only appropriate positioning of the hair cutting guide to achieve a proper taper.

The provision of a first handle and a second handle at opposing sides of the guide member is particularly advantageous as it allows the guide member to be held in either hand and allows the guide member to be more easily placed in an appropriate position, particularly when cutting one's own hair. There is much greater flexibility in positioning a guide member when a first handle and an opposing second handle are provided. In particular, the hair cutting guide of the present invention can be positioned much more easily than the hair cutting guide of the prior art discussed above.

Advantageously, the first handle and the second handle are attached to the guide such that the distal end of each handle is adjacent to a user's scalp during use of the guide. This is advantageous as it can increase stability during use, improve control when blending, and reduce flex of the guide member during use. Having the distal end of the first handle and the second handle positioned adjacent the user's scalp during use of the guide can help maintain a consistent position of the guide, resulting in a consistent cutting angle. It can also improve ergonomic control and reduce the potential for rotation of the wrist of the hand holding the guide.

The distal end of the first handle and the second handle can be positioned adjacent a user's scalp during use by positioning the distal ends adjacent the narrowest part of the haircutting guide in a direction perpendicular to the scalp, for example adjacent the proximal ends of the comb teeth.

In order to ensure that the guide is strong and does not excessively flex during use it may be advantageous that the guide further comprises a reinforced portion extending from the first side of the guide to the second side of the guide. The reinforced portion being a solid portion that does not comprise any guide teeth that may provide rigidity to the guide to avoid excessive flexing during use. A reinforced portion may be formed immediately adjacent the proximal ends of the comb teeth. If a reinforced portion is provided it may be used to provide a secure fixing of the handles to the guide. This may be achieved by having the distal end of the first handle and the distal end of the second handle directly connected to the reinforced portion.

The hair cutting guide is particularly advantageous as compared to previous hair cutting guides having only one handle as it allows a user to cut their own hair much more easily. In particular, when a user is cutting their own hair it can be difficult to position a hair cutting guide appropriately and then use the clippers. The provision of a first handle and a second handle at opposing sides of the guide member allows the hair cutting guide to be easily held in any suitable position against the user's scalp, by using an appropriate hand. This is not possible if a haircutting guide has only a single handle. If a haircutting guide has a single handle then that handle can be inappropriately positioned for at least portions of a user's scalp and it is then necessary for a third party to hold the haircutting guide in the appropriate position. The provision of a second, opposing handle overcomes this issue. With a second handle the hair cutting guide can be considered to be a “selfie” guide allowing a user to use the guide on their own, without another person.

The first handle and the second handle of the hair cutting guide can be positioned in any appropriate position that allows the hair cutting guide to be positioned against a user's scalp and allows the user to run mechanical clippers up an outer side of the guide member. In embodiments of the invention the first handle and/or the second handle may extend perpendicular to the lengths of the comb teeth to allow the handle to be easily held. The first handle and the second handle may extend in parallel but opposing directions.

The first handle and/or the second handle may be removably attached to the guide member, for example by a screw fitting, a click fitting or any other suitable fitting. A removable first handle and/or a removable second handle may be advantageous as it can allow the hair cutting guide to be packaged and/or stored in a more compact manner and can allow a handle to be used with different guide members having differing gradients of taper.

In embodiments of the invention the first handle may be formed a first unitary moulded item and/or the second handle may be formed as a second unitary moulded item and/or the guide member may be formed as a third unitary moulded item. Unitary moulded items can be formed from any suitable material including, but not limited to, thermoplastic polymers.

In embodiments of the invention the first handle and/or the second handle may be integrally formed with the guide member. This may be advantageous as it can provide a robust construction that is less breakable. If the first handle and the second handle are integrally formed with the guide member it may be advantageous that the hair cutting guide is a unitary moulded item; this can provide a robust and cheap construction.

In embodiments of the invention the plurality of comb teeth of the guide member may be identical to one another to define a consistent taper along a width. This can make the use of the hair cutting guide more consistent and straightforward, preventing uneven tapers being achieved when the guide is properly positioned adjacent a user's scalp by providing a uniform taper across a width of the guide member.

In order to provide improved usability the hair cutting guide may further comprise a laterally outer guard member at each side of the plurality of comb teeth; the guard members each extending along a length parallel to the comb teeth; wherein: the guard members are laterally spaced a distance greater than the width of a standard hair clipper and have a depth greater than the comb teeth to define a guide channel on an outer side of the taper for positioning a hair clipper. This can be advantageous as it can prevent a hair clipper from accidentally slipping off the outer side of the guide member when the hair cutting guide is in use. The guard members will act to laterally retain the hair clipper on an outer side of the guide member and thereby ensure the clipper cannot slip off. Guard members can be formed in any appropriate manner. In embodiments of the invention the guard members may consist of substantially flat plates, which may, for example, be formed of plastic or any other suitable material.

The first handle and the second handle of the hair cutting guide may be attached in any suitable position. In embodiments of the invention the first handle and/or the second handle of the hair cutting guide may be attached to a lateral side of a guide member located to a lateral side of the plurality of comb teeth. It may be advantageous that the first handle and/or the second handle is attached adjacent the distal ends of the plurality of comb teeth. Alternatively, it may be advantageous that that the first handle and/or the second handle is attached adjacent the proximal ends of the plurality of comb teeth.

The comb teeth of the guide member can be attached to one another in any manner apparent to the person skilled in the art. In embodiments of the invention the comb teeth are attached to one another at their proximal ends. In alternative embodiments the comb teeth are attached to one another at their distal ends. However, it is to be understood that any comb tooth can be attached to an adjacent comb tooth at substantially any point along its length and the skilled person will be able to readily determine how the comb tooth may be connected to one another. In embodiments of the invention the first handle and the second handle may be aligned with one another. In alternative embodiments of the invention the first handle and the second handle may be offset from one another.

Further features and advantages will be apparent from the embodiment of the invention shown in the drawings and described below. The embodiment described below is to be considered as purely exemplary and not limiting on the scope of the claims, the invention is as described in the claims. Unless otherwise indicated by context or defined in the claims, each of the features of the embodiment shown in the drawings can be combined with included in an embodiment of the invention in isolation from any other feature shown in the Figures and described below.

### BRIEF DESCRIPTION OF THE DRAWINGS

FIG. 1 is an image of a hair cutting guide according to the present invention.

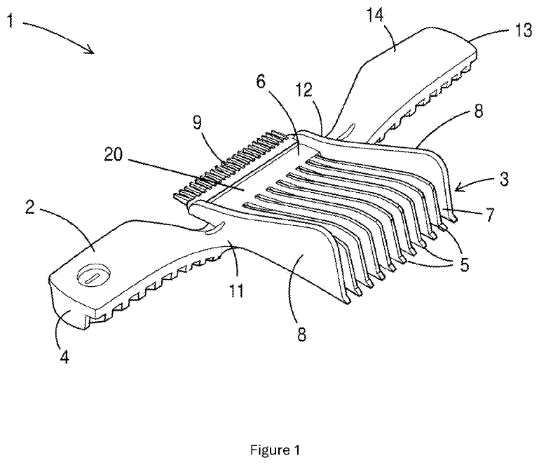

### DETAILED DESCRIPTION

A hair cutting guide 1 according to the present invention is shown in the Figures. The hair cutting guide 1 is being used to create a taper in a person's hair. The hair cutting guide 1 consists of a first handle 2, a second handle 14 and a guide member 3. The first handle 2 has a proximal end 11 and a distal end 4 and is attached to a first lateral side of the guide member 3 at the distal end 4 of the first handle 2. The second handle 14 has a proximal end 12 and a distal end 13 and is attached to a second lateral side of the guide member 3 at the distal end 13 of the second handle 4. The first lateral side of the guide member 3 opposes the second lateral side of the guide member 3. The guide member 3 forms a guide for mechanical clippers (not shown) to cut a taper into a person's hair (not shown). The hair cutting guide 1 is formed as a unitary moulded component from a resilient plastic.

The guide member 3 comprises a plurality of identical parallel comb teeth 5 that are evenly spaced across a lateral width of the guide member and each extend along a length from a proximal end 6 to a distal end 7. The comb teeth 5 are attached to one another at their proximal ends 6. The comb teeth 5 each have a depth in a direction perpendicular to the handle 2 and to their length. The depth of each comb tooth 5 increase from being relatively shallow at the proximal ends 6 of the comb teeth to relative deeper at the distal ends 7 of the comb teeth 5 to define a taper for haircutting. The depth of each comb tooth 5 increases at a substantially constant rate from the proximal end 6 to the distal end 7 to produce a constant increase in hair length from the proximal ends 6 to the distal ends 7.

A guard member 8 is provide at each laterally outer side of the guide member 3 to form a guide for the mechanical clippers. The guard members 8 extend in the same direction as the comb teeth 5 but have a greater depth such that the guide member 2 can still be held flat against the person's head and a channel is formed between the guard members 8 on an outer side of the guide member 2, to retain the clippers during hair cutting. A small comb member 9 is formed at the proximal end of the comb teeth to make it easier to position the hair cutting guide 1 appropriately.

A reinforced portion 20 is formed adjacent the proximal end 6 of the comb teeth 5. The reinforced portion 20 is a solid portion extending from a first side of the guide 1 to a second side of the guide. The reinforced portion 20 ensures the guide 1 remains rigid during use and does not flex. A small comb 9 is formed at an edge of the reinforced portion 20 to make it easier to position the hair cutting guide 1 appropriately adjacent a user's scalp. The distal end 11 of the first handle 2 is connected to a first side of the reinforced portion 20 and a distal end 12 of the second handle 14 is connected to a second side of the reinforced portion 20. This ensures that the first handle 2 and the second handle 14 are connected to the most rigid part of the guide 1 and unnecessary flex during use of the guide 1 is avoided.

The hair cutting guide 1 is used in the following manner. The guide 1 is held against the person's head in an appropriate position at which a taper is desired. Either the first handle 2 or the second handle 14 can be held by a user, as appropriate depending on where the user wishes to cut a taper and depending on which hand is the dominant hand of the user. The provision of a first handle 2 and a second handle 14 makes positioning of the hair cutting guide 1 much easier as compared to the prior art.

The guide is positioned by running the guide 1 upwards against the person's head, against the growth of the hair, to reach the desired position and such that the hair protrudes out of the guide. A hair clipper is then run up the outer side of the guide member 2 to cut the hair protruding out of the guide member. The guard members 8 retain the clipper on an outer side of the guide member 2 and make sure the clipper does not slip onto adjacent portions of the person's hair. This produces a taper in the person's hair at the position at which the hair cutting guide 1 was positioned; with a gradually increasing length of hair from a lower end of the person's head where the guide was positioned to an upper end. The hair cutting guide 1 can then be moved around the person's head to an adjacent position, to cut the taper in the adjacent position. The mechanical clipper should be used without a guard such that the hair is cut closely to the outer side of the guard member.

The portion of the person's hair above the taper should be cut to a first standard length substantially the same as the length of the hair at an upper end of the taper and the portion of the person's hair below the taper should be cut to a standard second length substantially the same as the length of the taper at a lower end of the taper. This can be achieved either using scissors or with mechanical clippers and an appropriate guard.

The first handle 2 and the second handle 14 are connected to the reinforced portion 20 of the guide 1. In use the reinforced portion 20 of the guide is held against a user's scalp. Therefore, the connection of the first handle 2 to the guide 1 and the connection of the second handle 14 to the guide 1 are both immediately adjacent a user's scalp when the guide 1 is in use. This allows a user to hold the guide in position in contact with their scalp more easily than if the connection of a handle 2, 14 is away from a user's scalp. It also make the use more ergonomic, avoids unnecessary flexion of the guide 1, and allows more consistent use of the guide 1.

1. A hair cutting guide consisting of:
a first handle adapted to be held by a user and having a distal end and a proximal end;
a second handle adapted to be held by a user and having a distal end and a proximal end; and
a guide member comprising a plurality of parallel comb teeth, each attached to one another, and extending along a length from a proximal end to a distal end;
wherein:
the distal end of the first handle is attached to a first side of the guide member;
the distal end of the second handle is attached to a second side of the guide member, opposing the first side; and
a depth of the comb teeth perpendicular to the lengths of the comb teeth increases from being relatively shallow at the proximal ends of the comb teeth to relatively deeper at the distal ends of the comb teeth to define a taper for haircutting.

2. A hair cutting guide according to claim 1, wherein the first handle and the second handle are attached to the guide such that the distal end of each handle is adjacent to a user's scalp during use of the guide.

3. A hair cutting guide according to claim 1, wherein the distal end of the first handle and the distal end of the second handle are positioned adjacent a narrowest part of the haircutting guide in a direction perpendicular to the scalp of a user when the guide is in use.

4. A hair cutting guide according to claim 1, wherein the distal end of the first handle and the distal end of the second handle are positioned adjacent the proximal ends of the comb teeth.

5. A hair cutting guide according to claim 1, wherein the guide further comprises a reinforced portion extending from the first side of the guide to the second side of the guide.

6. A hair cutting guide according to claim 5, wherein the reinforced portion is formed immediately adjacent the proximal ends of the comb teeth.

7. A hair cutting guide according to claim 5, wherein the distal end of the first handle and the distal end of the second handle are directly attached to the reinforced portion.

8. A hair cutting guide according to claim 1, wherein the first handle or the second handle extends perpendicular to the lengths of the comb teeth.

9. A hair cutting guide according to claim 1, wherein the first handle and the second handle extend perpendicular to the lengths of the comb teeth.

10. A hair cutting guide according to claim 9, wherein the first handle and the second handle are aligned with one another.

11. A hair cutting guide according to claim 1, wherein the first handle and/or the second handle is removably attached to the guide member.

12. A hair cutting guide according to claim 1, wherein the first handle is a first unitary moulded item, the second handle is a second unitary moulded item, and the guide member is a third unitary moulded member.

13. A hair cutting guide according to claim 1, wherein the first handle and the guide member are formed as a first unitary moulded member, and the second handle is formed as a second unitary moulded member.

14. A hair cutting guide according to claim 1, wherein the first handle and the second handle are integrally formed with the guide member.

15. A hair cutting guide according to claim 14, wherein the hair cutting guide is formed as a unitary moulded item.

16. A hair cutting guide according to claim 1, wherein the plurality of comb teeth are identical to one another.

17. A hair cutting guide according to claim 1, comprising a laterally outer guard member at each side of the plurality of comb teeth;
the guard members each extending along a length parallel to the comb teeth; wherein:
the guard members are laterally spaced a distance greater than the width of a standard hair clipper and have a depth greater than the comb teeth to define a guide channel on an outer side of the taper for positioning a hair clipper.

18. A hair cutting guide according to claim 17, wherein the guard members consist of substantially flat plates.

19. A hair cutting guide according to claim 1, wherein the first handle and/or the second handle is attached to the guide member adjacent the proximal ends of the plurality of comb teeth.

20. A hair cutting guide according to claim 1, wherein the comb teeth are attached to one another at their proximal ends.

21. A hair cutting guide according to claim 1, wherein the comb teeth are attached to one another at their distal ends.
